(19) United States
(12) Patent Application Publication
(10) Pub. No.: US 2008/0090942 A1
(43) Pub. Date: Apr. 17, 2008

(54) Tamper evident paint having microcapsules containing signal indicators

(76) Inventor: George Hovorka, East Boston, MA (US)

Correspondence Address: PEARSON & PEARSON, LLP, 10 GEORGE STREET, LOWELL, MA, 01852, US

(21) Appl. No.: 11/807,035

(22) Filed: May 25, 2007

Related U.S. Application Data
(60) Provisional application No. 60/809,463, filed on May 31, 2006.

(51) Int. Cl. C08K 9/10

(52) U.S. Cl. 523/200

(57) ABSTRACT

A method of providing a tamper evident paint comprising microcapsules enclosing signal indicators including dyes or odors which provide evidence of mechanical tampering after scratching or aggressively handling of a painted surface. An alternate embodiment of the tamper evident paint includes a microcapsule containing a magenta dye which stains the skin of a tamperor and can be seen when a resin solution is applied to the skin. Another embodiment includes a microcapsule containing a genetian violet dye dispersion which stains a tamperor's skin and is very difficult to remove. A further embodiment includes a microcapsule containing a fluorescent dye dispersion which attaches to the tamperor's skin and becomes visible under an ultraviolet light.

### CROSS-REFERENCE TO RELATED APPLICATIONS

This application claims the benefit of Provisional Application No. 60/809,463, filed May 31, 2006 which is incorporated herein by reference.

The United States Government has rights in this invention pursuant to Contract No. W91CRB-06-C-5006 awarded by the Department of Defense.

### BACKGROUND OF THE INVENTION

1. Field of the Invention

This invention relates generally to tamper monitoring of surfaces for asset protection and security monitoring and in particular to a method of providing a tamper evident paint having microcapsules containing dye or odor thereby providing evidence of mechanical tampering after scratching or aggressively handling of the painted surface.

2. Description of Related Art

Security concerns have heightened considerably in recent times, and the need for infrastructure protection, including prevention of terrorist attack, importation of the weapons of mass destruction, explosives, drugs and other contraband materials entering ports through shipping containers, has become urgent.

In the field of shipping containers, prior inventors have. employed electronic seals to store information whenever a container's doors are opened. However, such sealed systems fall short of present needs. For example, thieves can defeat seals by removing container doors from their hinges, and such systems typically employ battery-operated systems, which have limited life.

Other sensing technologies have been employed to detect tampering. For example, passive infrared sensors (PIRs) can detect the presence of warm bodies in a container or in a sensitive security zone. However, such PIRs can be easily blocked by the contents of a container or contaminated by dirt when used in outdoor applications. Moreover, such detectors require battery-operated systems, which have limited life, or complex hard-wiring to a power grid.

Ultrasonic motion sensors have also been employed for both perimeter monitoring and within shipping containers to detect the presence of tampering. However, they are prone to deterioration caused by dirt, moisture, and heat. These sensors are even more prone to false triggering than PIR methods due to heat waves from outdoor objects and from heat radiated into the container from the container walls which can reflect ultrasonic energy and thereby cause false alarms.

Complex video detection means have also been developed to indicate the presence of tampering of containers and for infrastructure security monitoring. These systems also require battery-operated systems, which have limited life, or complex hard-wiring to a power grid, and in addition require either humans to monitor the video images or complex computer algorithms to detect the presence of tampering.

All of the heretofore methods thus appear to have a major deficiency in that they require a power source and complex electronic systems to indicate the presence of tampering.

U.S. Pat. No. 4,226,194 issued Oct. 7, 1980 to Donald T. Grahn discloses a method for chemically labeling and thereby subsequently detecting and identifying stolen articles and the thief by means of a latex color reagent containing as an active ingredient ninhydrin or hydridantin or a mixture thereof. A second material such as an amino acid reacts with the active ingredient ninhydrin causing a colored reaction product to form on a portion of the article. However, this method does not disclose the use of microcapsules in tamper evident paint to facilitate covering various surfaces.

The following U.S. Patent relates to the use of microcapsules for containing dye or odor. A wide variety of processes exist by which microcapsules can be manufactured. These varied processes provide different techniques for producing capsules of varying size, alternative materials for the composition of the capsule shell and various different functional materials within the shell. Examples of such processes are disclosed in U.S. Pat. No. 3,516,846 and U.S. Pat. No. 3,516,941 both issued Jun. 23, 1970 to Gale W. Matson and assigned to Minneapolis Mining and Manufacturing Company of Minneapolis, Minn.

Other suitable methods of microencapsulation include those methods taught in U.S. Pat. Nos. 3,778,383; 4,087,376; 4,089,802; 4,100,103 and 4,251,386 and British patent specification Nos. 1,156,725; 2,041,319 and 2,048,206. A wide variety of different materials may be used in making the capsule shells, including gelatin and synthetic polymeric materials. A preferred method of polymerization reaction involves the reaction between urea and formaldehyde or melamine and formaldehyde, or the polycondensation products of monomeric or low molecular weight polymers of dimethylolurea or methylolated urea with aldehydes. A variety of capsule forming materials are disclosed, for example, in U.S. Pat. Nos. 3,516,846 and 4,087,376 and in British patent specification Nos. 2,006,709 and 2,062,570.

U.S. Pat. No. 4,493,869 issued Jan. 15, 1985 to Norman P. Sweeney, et al. and assigned to Minnesota Mining and Manufacturing Company of St. Paul, Minn. discloses a fragrance releasing article comprising microcapsules. When the microcapsules are ruptured by pressure or applied shear to the capsule layer, e.g. by scratching or impacting, a liquid is released which readily volatizes resulting in the fragrance. However, it does not disclose mixing the fragrance microcapsules in paint for indicating mechanical tampering after the paint is applied to a surface.

U.S. Pat. No. 4,936,607 issued Jun. 26, 1990 to Robert W. Brunea et al discloses a method for microencapsulating a fluorescent material that remains inert until the material is ruptured for use in preventing altering information printed on a document. However, it does not disclose the use of microcapsules for making tamper evident paint.

### SUMMARY OF THE INVENTION

Accordingly, it is therefore an object of this invention to provide a method for manufacturing a tamper evident paint having microcapsules containing tamper indicators such as a dye or odor.

It is a further object of this invention to provide evidence of mechanical tampering after the tamper evident paint is applied to an object and then scratched or aggressively handled.

It is another object of this invention to provide a tamper evident paint with microcapsules that provides a visual color change, a latent color development, a visual skin marking, a fluorescent skin marking or that generate an odor.

It is yet another object of this invention to provide a paint made by a process that incorporates a tamper signal indicator enclosed within a microcapsule dispersion which is mixed with a latex based tint to form a paint composition.

These and other objects are further accomplished by a process for making paint by mixing a signal indicator in a precursor material, microencapsulating the precursor material to form microcapsules containing the precursor material dispersed within a carrier, and mixing a first predetermined amount of the microcapsule carrier with a second predetermined amount of a latex base tint to form a paint composition. The process further comprises the step of mixing approximately 100 mg of a phenolic resin powder per gram of the paint composition to form a tamper evident paint. The step of mixing a precursor material comprises the step of mixing a colored dye with a paraffin oil to make a 10% by weight dye precursor solution. The step of microencapsulating the precursor material comprises the step of forming approximately 10-20 micron diameter microcapsules in a water slurry having approximately 60% by weight concentration. The step of mixing the microcapsule carrier with the latex base tint comprises the step of mixing 300 mg of the first undetermined amount of the microcapsule carrier per gram of the latex base tint.

The objects are further accomplished by a method of manufacturing a visual color changing tamper evident paint comprising the steps of providing a dye precursor, mixing the dye precursor with a paraffin oil to make a 10% by weight dye precursor solution, microencapsulating the dye precursor solution to form a slurry having 10-20 micron microcapsules in a water slurry having approximately 60% microcapsules by weight concentration in water, mixing approximately 300 mg of the microcapsule slurry per gram of a latex base tint forming a composition, and mixing approximately 100 mg of a phenolic resin per gram of the composition to form the tamper evident paint. The step of providing a dye precursor comprises the step of providing a magenta dye precursor. The step of microencapsulating the dye precursor comprises the steps of providing a prepolymer solution, and adding the dye precursor solution to the prepolymer solution at a predetermined temperature in accordance with a predetermined arrangement of secondary ingredients to form the microcapsules. The method further comprises the steps of applying the tamper evident paint to a surface and observing the surface at various intervals for a color indicating tampering has occurred.

The objects are further accomplished by a method of manufacturing a latent color development tamper evident paint comprising the steps of providing a dye precursor, mixing the dye precursor with a paraffin oil to make a 10% by weight dye precursor solution, microencapsulating the dye precursor solution to form a slurry having 10-20 micron diameter microcapsules in a water slurry having approximately 60% microcapsules by weight concentration in water, and mixing approximately 300 mg of the microcapsule slurry per gram of a latex base tint forming a composition. The step of providing a dye precursor comprises the step of providing a magenta dye precursor. The step of microencapsulating the dye precursor comprises the steps of providing a prepolymer solution, and adding the dye precursor solution to the prepolymer solution at a predetermined temperature in accordance with a predetermined arrangement of secondary ingredients to form the microcapsules. The method further comprises the steps of applying the tamper evident paint to a surface, grinding approximately 1 gram of phenolic resin into approximately 10 grams of water to form a developing solution, applying the developing solution to the surface having the tamper evident paint, and observing the surface for a color indicating tampering has occurred.

The objects are further accomplished by a method of manufacturing a visual skin marking tamper evident paint comprising the steps of providing a dye precursor, mixing the dye precursor with a mineral oil to make a 40% by weight dye dispersion, microencapsulating the dye dispersion to form a powder having approximately 100 micron diameter microcapsules in the powder, adding approximately 10 mg of water to each gram of a latex base tint to form a diluted latex base tint, and mixing approximately 300 mg of the microcapsule powder per gram of diluted latex base tint forming the tamper evident paint. The step of providing a dye precursor comprises the step of providing Genetian violet pigment for the dye precursor. The step of microencapsulating the dye dispersion. comprises the steps of providing a prepolymer solution, and adding the dye dispersion to the prepolymer solution at a predetermined temperature in accordance with a predetermined arrangement of secondary ingredients to form the microcapsules. The method further comprises the steps of applying the tamper evident paint to a surface, and observing stained skin of a tamperor who aggressively handled the surface having tamper evident paint.

The objects are further accomplished by a method of manufacturing a fluorescent stain marking tamper evident paint comprising the steps of providing an optical brightener dye, mixing the optical brightener dye with a mineral oil to make a 10% optical brightener by weight dye dispersion, microencapsulating the optical brightener dye dispersion to form a powder having approximately 100 micron diameter microcapsules in the powder, adding approximately 10 mg of water to each gram of a latex base tint to form a diluted latex base tint, mixing approximately 300 mg of the microcapsule powder per gram of diluted latex base tint forming the tamper evident paint. The step of providing an optical brightener dye comprises the step of providing a fluorescent optical brightener dye. The step of microencapsulating the optical brightener dye dispersion comprises the steps of forming a prepolymer solution by heating a mixture of six moles of 37% aqueous formaldehyde and four moles of urea adjusted to pH 8.0 for one hour at 70° C., mixing water-insoluble dye precursor solution into the prepolymer solution and rapidly mixing until the desired capsular size is reached, heating the mixture to 70° C. and maintaining the pH at 8.0 for a period of one hour while maintaining the mixing, changing the pH of the mixture to 3.8 with 10% of citric acid solution, continuing the reaction for a period of one-half hour at 70° C. while maintaining the mixing; and adding water to dilute the thickening mixture and changing the reaction temperature to 55° C. while mixing for an additional 60 minutes. The method further comprises the steps of applying the tamper evident paint to a surface, and examining stained skin of the tamperor with an ultraviolet light source after the tamperor has aggressively handled the surface having tamper evident paint.

The objects are further accomplished by a method of manufacturing an odor generating tamper evident paint comprising the steps of providing a scented oil precursor, mixing the scented oil with a mineral oil to make a 40% by weight scented solution, microencapsulating the scented solution to form a powder having approximately 100 micron diameter microcapsules in the powder, adding approximately 10 mg of water to each gram of a latex base tint to form a diluted latex base tint, and mixing approximately 300 mg of the microcapsule powder per gram of diluted latex base tint to form the odor generating tamper evident paint. The step of providing a scented oil comprises the step of providing a scented flower oil. The step of microencapsulating the dye dispersion comprises the steps of providing a prepolymer solution, forming a non-formaldehyde polymer shell, and encapsulating the scented oil within the shell. The method further comprises the steps of applying the temper evident paint to a surface, and sensing an odor after a tamperor aggressively handles the surface having tamper evident paint.

Additional objects, features and advantages of the invention will become apparent to those skilled in the art upon consideration of the following detailed description of the preferred embodiments exemplifying the best mode of carrying out the invention as presently perceived.

### BRIEF DESCRIPTION OF THE DRAWINGS

The appended claims particularly point out and distinctly claim the subject matter of this invention. The various objects, advantages and novel features of this invention will be more fully apparent from a reading of the following detailed description in conjunction with the accompanying drawings in which like reference numerals refer to like parts, and in which:

FIG. 1 is a flow chart of a method for manufacturing visual color changing tamper evident paint according to the present invention.

FIG. 2 is a flow chart of a method for manufacturing a latent color development alternate embodiment of the tamper evident paint according to the present invention.

FIG. 3 is a flow chart of a method for manufacturing a visual skin marking alternate embodiment of the tamper evident paint according to the present invention.

FIG. 4 is a flow chart of a method for manufacturing a fluorescent skin marking alternate embodiment of the tamper evident paint according to the present invention.

FIG. 5 is a flow chart of a method for manufacturing an odor generating alternate embodiment of the tamper evident paint according to the present invention.

### DESCRIPTION OF ILLUSTRATIVE EMBODIMENTS

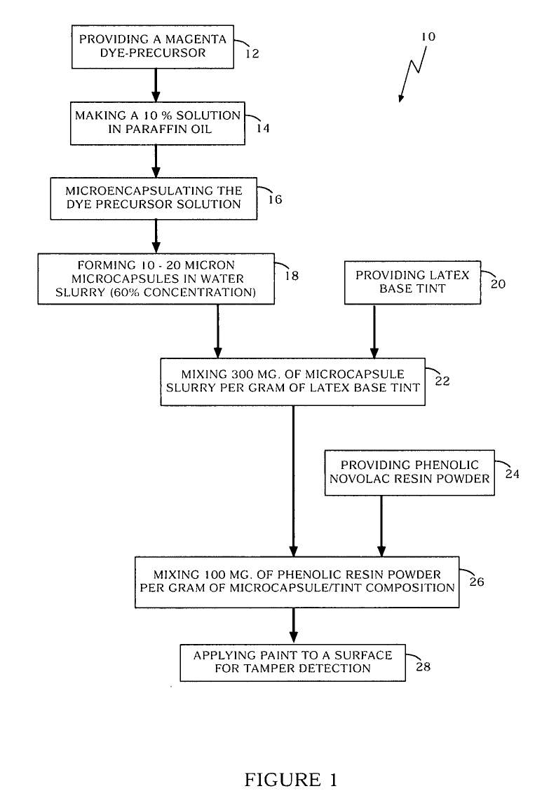

Referring to FIG. 1, a flow chart shows a method 10 for manufacturing visual color changing tamper evident paint according to the present invention. In steps 12 and 14 a pre-polymer solution is formed by mixing a dye precursor having a magenta color with a normal paraffin oil such as Norpar 15 to make a 10% by weight dye precursor solution. The magenta dye precursor may be embodied with Copikem 20 made by Hilton Davis Chemical Company of Cincinnati, Ohio. Copikem 20 is generally known as a leuco dye and more specifically its chemical formula is: 3,3-bis-[1-butyl-2-methyl-1H-indol-3-yl]-1-isobenzofuranone and has a CAS number 50292-91-6. The Norpar 15 is available from Exxon Corp. of Houston, Tex. Norpar 15 is a normal paraffin hydrocarbon fluid which contains a mixture of C-13 through C-17 linear chain carbons. It has a flash point of 120° C., density (at 15° C.)of 0.772 kg/dm³, and viscosity (at 25° C.) of 3.27 mm²/s. In step 16 the water-insoluble 10% by weight dye precursor solution is microencapsulated with a urea-formaldehyde capsule wall as described in U.S. Pat. No. 3,516,846 which is incorporated herein by reference. The process of encapsulation has achieved widespread commercial success over a period of 37 years. Companies which routinely create custom microencapsulates include Capsulated Systems of Yellow Springs, Ohio and Aveka of Minneapolis, Minn. The process is described in the '846 patent as Example 2 starting in column 8, line 30, and the result is a capsule slurry which is gravity filtered and partially air dried.

The microcapsules are produced by the process comprising the steps of forming a prepolymer solution by heating a mixture of six moles of 37% aqueous formally and four moles of urea adjusted to pH 8.0 for one hour at 70° C., mixing water-insoluble dye precursor solution into the prepolymer solution and rapidly mixing until the desired capsular size is reached, heating the mixture to 70° C. and maintaining the pH at 8.0 for a period of one hour while maintaining the mixing, changing the pH of the mixture to 3.8 with 10% of citric acid solution, continuing the reaction for a period of one-half hour at 70° C. while maintaining the mixing, and then adding water to dilute the thickening mixture and changing the reaction temperature to 55° C. while mixing for an additional 60 minutes. As a result of the microencapsulating steps 16, 18, 10-20 micron diameter particles are formed in an approximate 60% by weight concentration in water.

Next in steps 20 and 22, a latex base tint is provided and mixing 300 mg of the microcapsule slurry per gram of the latex base tint produces a composition. In step 24, a finely ground phenolic resin powder (Novolac HRJ-2053) is provided and in step 26 mixing 100 mg of the phenolic resin powder per gram of the composition from step 22 occurs resulting in the tamper evident paint which is thoroughly mixed using conventional paint mixing equipment. The latex base tint may be embodied by Glidden 6113 made by ICI Paints of Strongsville, Ohio, and the phenolic resin powder may be embodied by Novolac Type HRJ-2053 manufactured by SI Group, Inc. of Schenectady, N.Y. Novolac resin is a zincated alkylphenol-formaldehyde resin, and it has a melting point of 110° C.

In step 28, applying the visual color tamper evident paint to a surface occurs utilizing conventional painting apparatus such as a brush or roller. After the paint has thoroughly dried, mechanical tampering of the surface such as scratching or a hammer blow will cause the paint to change from its initial color to magenta in the areas where tampering has occurred. This is due to the colorless dye precursor in the ruptured microcapsules combining with the phenolic resin present in the paint.

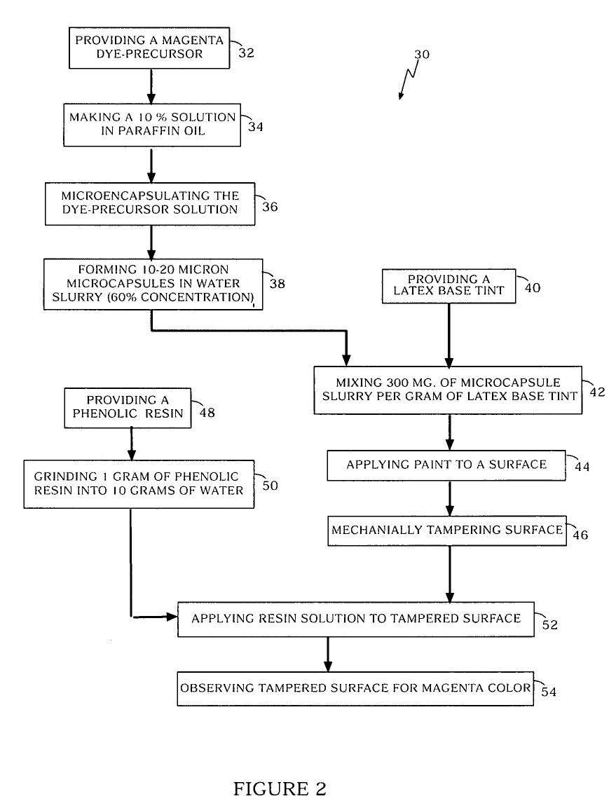

Referring to FIG. 2, a flow chart is shown of a method 30 for manufacturing a latent color development alternate embodiment of the tamper evident paint according to the present invention. Steps 32 through 42 are the same process as steps 12 through 22 of the visual color changing method of FIG. 1. Step 20 in FIG. 1 is omitted from the method of FIG. 2. In step 44 applying the paint from step 42 to a surface occurs. However, when mechanically tampering the surface occurs in step 46, no evidence of tampering will be apparent until a developing solution is applied. Such a developing solution is formed in steps 48 and 50 by grinding 1 gram of a phenolic resin into 10 grams of water. Grinding is continued until a fine dispersion of resin in water is achieved. In step 52 applying the dispersion from step 50 to the surface where tampering is suspected occurs, and if tampering did occur as in step 46, a magenta color on the surface will be observed in step 54 due to the reaction between the exposed dye precursor as a result of tampering in Step 46 and the phenolic resin dispersion from Step 50. The phenolic resin is embodied by Type HRJ-2053 manufactured by Schenectady International, and the latex base tint may be embodied by Glidden 6113.

The composition of a paint formulation serving as a vehicle for a signal coating is not overly critical as long as the formulation and the ultimate protective covering derived there from adequately mask, i.e., render invisible or inconspicuous the visual, olfactory, skin marking indicators or combinations thereof. Both interior paints and exterior paints can be used as signal coating carriers, though exterior paints, and especially aqueous latex paints, are particularly relevant. Of course there are other variations of paint within the spirit and scope of the invention that will occur to those skilled in the art. For example, it will be understood that suitable microcapsules can be mixed with other types of paints, such as urethanes, acrylics, lacquers, shellac, epoxy, or other paints typically used for both indoor and outdoor applications.

“Signal coating”, as used herein, means a substance which exists in a substantially colorless or odorless state and is in an indistinct or visually non-discernible form in the paint formulation or protective coating formed thereby, and which converts to a colored, fluorescent, olfactory, skin marking and/or latent image tampering evidence form upon mechanical tampering of the coated surface causing rupturing of the microcapsules contained within.

The coating formulation must not trigger premature conversion of the visual, olfactory, skin marking, latent image tampering evidence, or combinations thereof to its native, non-encapsulated indicator form. To this end it is preferable to encapsulate the visual, fluorescent, olfactory, or skin marking indicators or combinations thereof in a plurality of pressure-rupturable microcapsules, so that the signal indicator remains dormant until the paint is physically tampered with, i.e., until the signaling function is required. The microcapsules preferably can be ruptured upon striking or prying the protective surface through conventional mechanical means such as pliers, prybars, hammers and the like. Pressure-rupturable microcapsules that are not pH sensitive are preferred where the paint formulations may pre-activate the indicator to its signaling form or where the paint formulations may tend to dissolve into the encapsulated material.

The encapsulating material is selected to be compatible with the particular paint or protective coating and to be compatible with an outdoor exposure and also to permit sufficient washability, and to provide abrasion resistance, impact resistance, and the like, of the applied coating without a premature activation of the signal coating.

In all embodiments of the present invention the signal substances are incorporated into a coating which is preferably a water-based, latex-type exterior paint which is substantially a stable dispersion in water of aqueous emulsion copolymers pigmented as desired to provide the coloration, and as needed to mask the microcapsules that are present and to provide an opaque coating. The term “aqueous emulsion copolymer” as used herein, denotes copolymers or interpolymers produced by the copolymerization of a liquid mixture of polymerizable monomers in an aqueous medium. For a stable dispersion, the polymerized product is colloidal, and preferably has a particle size of about 3 microns or less.

The polymerizable monomers of choice for the latex are butyl acrylate and vinyl acetate, however, numerous other ethylenically unsaturated monomers can be used, for example, methyl acrylate, ethyl acrylate, methyl methacrylate, styrene, 2-ethylhexylacrylate, vinyl toluene, acrylonitrile, vinylidene chloride, and the like. However, a wide variety of latex paint formulations are suitable vehicles.

Preferably the polymerizable monomers are selected so as to produce a copolymer having a glass transition temperature (T.sub.g) below room temperature so that the individual copolymer particles, when applied on a selected surface as a coating, will coalesce by themselves to provide a substantially continuous polymeric film without the need to apply external heat.

The amount of visual, olfactory or skin marking indicator or combinations thereof present in a coating formulation is not overly critical provided a sufficient amount is present to signal tampering as discussed herein above. Of course, the amount of signal coating present should not be so great as to adversely affect the characteristics of the coating formulation itself.

For a particular coating formulation the size and amount of signal coating-containing microcapsules are selected so as not to affect substantially the stability, hiding power, tinting strength, burnish resistance, abrasive scrub resistance, stain removal, rheology, adhesion, film coalescence, and color stability of the coating formulation itself. However, the amount and distribution of the signal coating-containing microcapsules should be such as to provide a sufficient number of microcapsules which release the signal coating when a portion of the protective or decorative polymeric film that is formed by the formulation is ruptured.

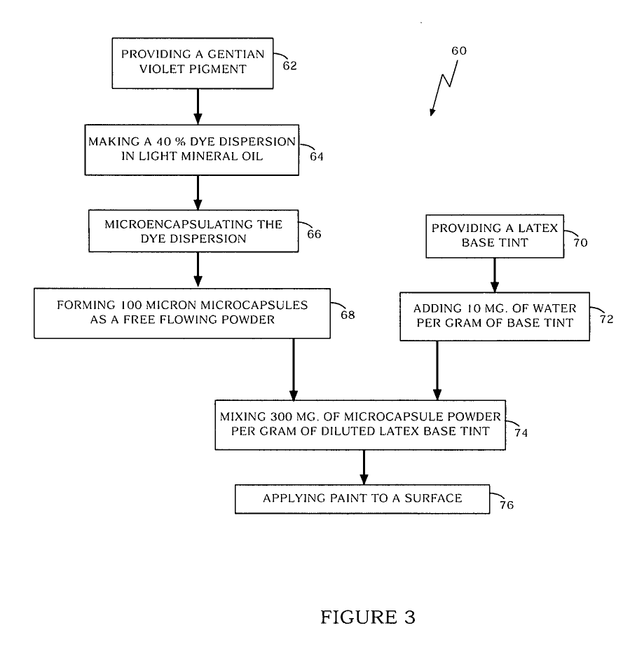

Referring now to FIG. 3 a flow chart is shown of a method 60 for manufacturing a visual skin marking alternate embodiment of the tamper evident paint according to the present invention. In this method a tampering indicator or a stain ends up on the fingers of the tamperor which cannot be seen and is not easily removed. In steps 62 and 64 a pre-polymer solution is formed by ball mill grinding a Genetian Violet dye with light mineral oil resulting in a 40% by weight dye suspension in mineral oil. Microencapsulating the dye dispersion with a urea-formaldehyde wall occurs in steps 66 and 68 in accordance with the process described in U.S. Pat. No. 3,516,846 (Column 7, Example 1), which is incorporated herein by reference, forming 100 micron diameter microcapsules as a free flowing powder. The microcapsules are produced by the process comprising the steps of forming a prepolymer solution by heating a mixture of six moles of 37% aqueous formaldehyde and four moles of urea adjusted to pH 8.0 for one hour at 70° C., mixing water-insoluble dye precursor solution into the prepolymer solution and rapidly mixing until the desired capsular size is reached, heating the mixture to 70° C. and maintaining the pH at 8.0 for a period of one hour while maintaining the mixing, changing the pH of the mixture to 3.8 with 10% of citric acid solution, continuing the reaction for a period of one-half hour at 70° C. while maintaining the mixing, and then adding water to dilute the thickening mixture and changing the reaction temperature to 55° C. while mixing for an additional 60 minutes.

In steps 70 and 72 a latex base tint is provided and diluted by adding 10 mg of water per gram of the latex base tint. In step 74 mixing 300 mg of the microcapsule powder from step 68 occurs with each gram of the diluted latex base tint from step 72 forms the tamper evident paint which is thoroughly mixed utilizing conventional paint mixing equipment. In step 76 applying the paint to a surface occurs with conventional painting apparatus such as a brush or roller. After the paint has thoroughly dried aggressive handling of the surface will cause skin staining to occur while casually touching the surface will cause no dye release. The skin staining occurs when the Genetian Violet dye is released from mechanically ruptured microcapsules within the paint. When this dye contacts the skin, it travels into the pores and lodges itself underneath the outer dermal layer making it difficult to remove. The Gentian Violet dye may be obtained from Signa Aldrich Chemical Company of Milwaukee, Wis., and the light mineral oil may be embodied by Type Light Viscosity, Technical Grade, made by PTI Process Chemicals of Ringwood, Ill. The latex base tint may be embodied by Glidden 6113.

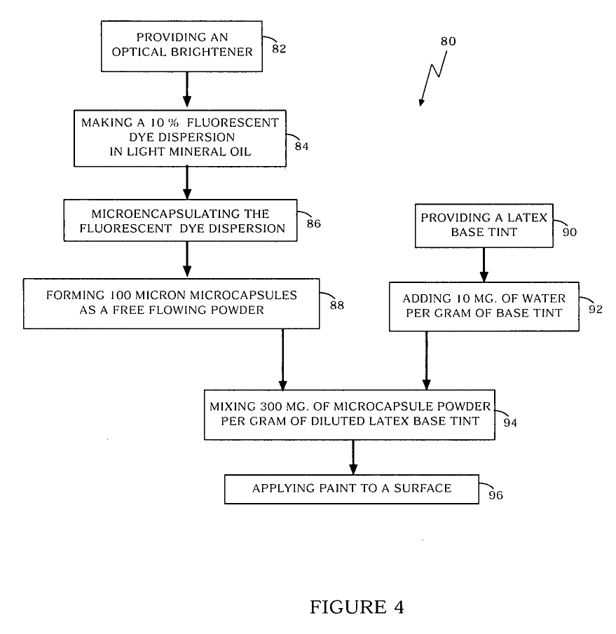

Referring to FIG. 4, a flow chart shows a method 80 for manufacturing a fluorescent stain marking alternate embodiment of the tamper evident paint according to the present invention. Fluorescent indicators produce a color reaction in the presence of ultraviolet. Further, fluorescent indicators are those molecules which when they undergo absorption of ultraviolet light, an electron is promoted from the ground state to an excited singlet state. Immediately after promotion, the electron drops to the lowest-energy singlet state. The excited molecule with its electrons in this lowest-energy singlet state can return to the ground state by losing energy as light. The energy lost by this emission of light is slightly less than the energy that was initially absorbed. Therefore, the wavelength of the light emitted is slightly longer than the wavelength that was initially absorbed. The term “fluorescent indicator” as used herein means those molecules which absorb light in the ultraviolet region and emit light in the visible region so that an image is produced which is invisible in visible light but becomes visible under ultraviolet light to the naked eye.

In steps 82 and 84, a pre-polymer solution is formed by ball mill grinding an optical brightener such as Nylocel CN with a light mineral oil making a 10% by weight fluorescent dye dispersion in the light mineral oil. Microencapsulating the fluorescent dye dispersion with a urea-formaldehyde capsular wall occurs in steps 86 and 88 in accordance with the process described in U.S. Pat. No. 3,516,846 (Column 7, Example 1), as described heretofore and incorporated herein by reference, forming 100 micron diameter microcapsules as a free flowing powder. The microcapsules are produced by the process comprising the steps of forming a prepolymer solution by heating a mixture of six moles of 37% aqueous formaldehyde and four moles of urea adjusted to pH 8.0 for one hour at 70° C., mixing water-insoluble dye precursor solution into the prepolymer solution and rapidly mixing until the desired capsular size is reached, heating the mixture to 70° C. and maintaining the pH at 8.0 for a period of one hour while maintaining the mixing, changing the pH of the mixture to 3.8 with 10% of citric acid solution, continuing the reaction for a period of one-half hour at the 70° C. while maintaining the mixing, and then adding water to dilute the thickening mixture and changing the reaction the reaction temperature to 55° C. while mixing for an additional 60 minutes.

In steps 90 and 92 a latex base tint is provided and diluted by adding 10 mg of water per gram of the latex base tint. In step 94 mixing 300 mg of microcapsule powder from step 88 with each gram of the diluted latex base tint from step 92 forms the fluorescent skin staining tamper evident paint which is thoroughly mixed utilizing conventional paint mixing equipment. In step 96 applying the paint to a surface occurs with conventional painting apparatus such as a brush or roller. After the paint has thoroughly dried, aggressive handling of the surface will cause fluorescent skin staining to occur, while casually touching the surface will cause no dye release. The skin staining occurs when the optical brightener dye is released from the mechanically ruptured microcapsules. When this dye contacts a person's skin, it will lodge into the pores such that when the skin is subsequently examined with a long wavelength ultraviolet light source, skin stains from tampering will be readily apparent. The ultraviolet light source may be embodied by Model UVL-21 manufactured by Ultraviolet Products of Upland, Calif. The optical brightener may be embodied by Type Nylocel Conn. manufactured by Robert Koch Industries of Bennett, Col. It is an umbelliferone dye also known as 7-hydroxycoumarin which absorbs light in the ultraviolet violet region of the spectrum and re-emits light in the blue region. The light mineral oil may be embodied by Type Light Viscosity, Technical Grade made by PTI Process Chemicals of Ringwood, Ill. The latex base tint may be embodied by Glidden 6113.

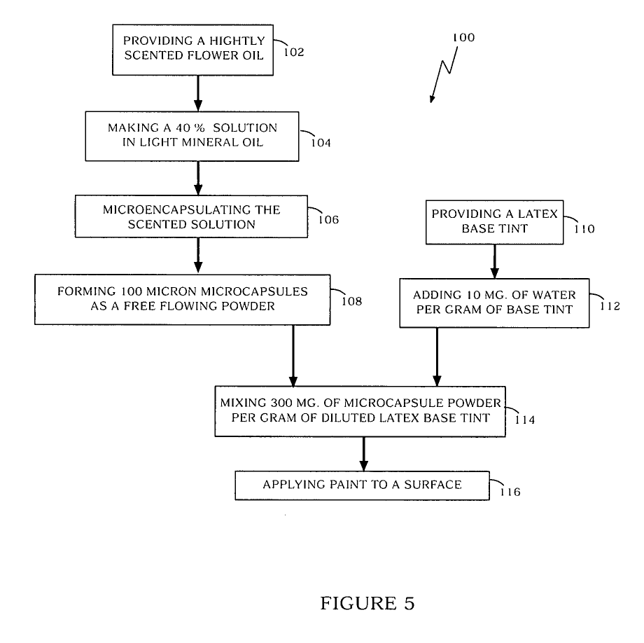

Referring to FIG. 5, a flow chart is shown of a method 100 for manufacturing an odor generating embodiment of the tamper evident paint according to the present invention. In steps 102 and 104 a pre-polymer solution is formed by mixing an intense odorant with a light mineral oil making a 40% by weight odorant in the mineral oil solution. Microencapsulating this water insoluble organic liquid with a urea-formaldehyde capsular wall occurs in steps 106 and 108 in accordance with the process described in U.S. Pat. No. 3,516,846 (Column 8, Example 2) and incorporated herein by reference, forming 100 micron microcapsules as a free flowing powder. The microcapsules are produced by the process comprising the steps of forming a prepolymer solution by heating a mixture of six moles at 37% aqueous formaldehyde and four moles of urea adjusted to pH 8.0 for one hour at 70° C., mixing water-insoluble dye precursor solution into the prepolymer solution and rapidly mixing until the desired capsular size is reached, heating the mixture to 70° C. and maintaining the pH at 8.0 for a period of one hour while maintaining the mixing, changing the pH of the mixture to 3.8 with 10% of citric acid solution, continuing the reaction for a period of one-half hour at 70° C. while maintaining the mixing, and then adding water to dilute the thickening mixture and changing the reaction temperature to 55° C. while mixing for an additional 60 minutes.

In steps 110 and 112 a latex base tint is provided and diluted by adding 10 mg of water per gram of the latex base tint. In step 114 mixing 300 mg of microcapsule powder from step 108 with each gram of the diluted latex base tint from step 112 forms odor tamper evident paint which is thoroughly mixed utilizing conventional paint mixing equipment. In step 116 applying the odor generating paint to a surface occurs with conventional painting apparatus such as a brush or roller. After the paint has thoroughly dried, aggressive handling of the surface will cause the odor generating oil to release from the mechanically ruptured microcapsules, while casually touching the surface will cause no odor release. The odorant in step 102 may be embodied by Ylang-Ylang intense floral odorant available from Liberty Natural Products Company of Oregon City, Ore. The light mineral oil may be embodied by Type Light Viscosity Technical Grade made by PTI Process Chemicals of Ringwood, Ill. The latex base tint may be embodied by Glidden 6113.

This invention has been disclosed in terms of several preferred embodiments. It will be apparent that many modifications can be made to the disclosed method and apparatus without departing from the invention. Therefore, it is the intent of the appended claims to cover all such variations and modifications as come within the true spirit and scope of this invention.

What is claimed is:

1. A paint made by a process of:
mixing a signal indicator in a precursor material;
microencapsulating said precursor material to form microcapsules containing said precursor material dispersed within a carrier;
mixing a first predetermined amount of said microcapsule carrier with a second predetermined amount of a latex base tint to form a paint composition.

2. The process as recited in claim 1 further comprises the step of mixing approximately 100 mg of a phenolic resin powder per gram of said paint composition to form a tamper evident paint.

3. The process as recited in claim 1 wherein said step of mixing a precursor material comprises the step of mixing a colored dye with a paraffin oil to make a 10% by weight dye precursor solution.

4. The process as recited in claim 1 wherein said step of microencapsulating said precursor material comprises the step of forming approximately 10-20 micron diameter microcapsules in a water slurry having approximately 60% by weight concentration.

5. The process as recited in claim 1 wherein said step of mixing said microcapsule carrier with said latex base tint comprises the step of mixing 300 mg of said first undetermined amount of said microcapsule carrier per gram of said latex base tint.

6. A method of manufacturing a visual color changing tamper evident paint comprising the steps of:
providing a dye precursor;
mixing said dye precursor with a paraffin oil to make a 10% by weight dye precursor solution;
microencapsulating said dye precursor solution to form a slurry having 10-20 micron microcapsules in a water slurry having approximately 60% microcapsules by weight concentration in water;
mixing approximately 300 mg of said microcapsule slurry per gram of a latex base tint forming a composition; and
mixing approximately 100 mg of a phenolic resin per gram of said composition to form said tamper evident paint.

7. The method as recited in claim 6 wherein said step of providing a dye precursor comprises the step of providing a magenta dye precursor.

8. The method as recited in claim 6 wherein said step of microencapsulating said dye precursor comprises the steps of:
providing a prepolymer solution;
adding said dye precursor solution to said prepolymer solution at a predetermined temperature in accordance with a predetermined arrangement of secondary ingredients to form said microcapsules.

9. The method as recited in claim 6 further comprises the steps of:
applying said tamper evident paint to a surface; and
observing said surface at various intervals for a color indicating tampering has occurred.

10. A method of manufacturing a latent color development tamper evident paint comprising the steps of:
providing a dye precursor;
mixing said dye precursor with a paraffin oil to make a 10% by weight dye precursor solution;
microencapsulating said dye precursor solution to form a slurry having 10-20 micron diameter microcapsules in a water slurry having approximately 60% microcapsules by weight concentration in water; and
mixing approximately 300 mg of said microcapsule slurry per gram of a latex base tint forming a composition.

11. The method as recited in claim 10 wherein said step of providing a dye precursor comprises the step of providing a magenta dye precursor.

12. The method as recited in claim 10 wherein said step of microencapsulating said dye precursor comprises the steps of:
providing a prepolymer solution;
adding said dye precursor solution to said prepolymer solution at a predetermined temperature in accordance with a predetermined arrangement of secondary ingredients to form said microcapsules.

13. The method as recited in claim 10 further comprises the steps of:
applying said tamper evident paint to a surface;
grinding approximately 1 gram of phenolic resin into approximately 10 grams of water to form a developing solution;
applying said developing solution to said surface having said tamper evident paint; and
observing said surface for a color indicating tampering has occurred.

14. A method of manufacturing a visual skin marking tamper evident paint comprising the steps of:
providing a dye precursor;
mixing said dye precursor with a mineral oil to make a 40% by weight dye dispersion;
microencapsulating said dye dispersion to form a powder having approximately 100 micron diameter microcapsules in said powder;
adding approximately 10 mg of water to each gram of a latex base tint to form a diluted latex base tint; and
mixing approximately 300 mg of said microcapsule powder per gram of diluted latex base tint forming said tamper evident paint.

15. The method as recited in claim 14 wherein said step of providing a dye precursor comprises the step of providing Genetian violet pigment for said dye precursor.

16. The method as recited in claim 14 wherein said step of microencapsulating said dye dispersion comprises the steps of:
providing a prepolymer solution; and
adding said dye dispersion to said prepolymer solution at a predetermined temperature in accordance with a predetermined arrangement of secondary ingredients to form said microcapsules.

17. The method as recited in claim 14 further comprises the steps of:
applying said tamper evident paint to a surface; and
observing stained skin of a tamperor who aggressively handled said surface having tamper evident paint.

18. A method of manufacturing a fluorescent stain marking tamper evident paint comprising the steps of:
providing an optical brightener dye;
mixing said optical brightener dye with a mineral oil to make a 10% optical brightener by weight dye dispersion;
microencapsulating said optical brightener dye dispersion to form a powder having approximately 100 micron diameter microcapsules in said powder;
adding approximately 10 mg of water to each gram of a latex base tint to form a diluted latex base tint; and
mixing approximately 300 mg of said microcapsule powder per gram of diluted latex base tint forming said tamper evident paint.

19. The method as recited in claim 18 wherein said step of providing an optical brightener dye comprises the step of providing a fluorescent optical brightener dye.

20. The method as recited in claim 18 wherein said step of microencapsulating said optical brightener dye dispersion comprises the steps of:
forming a prepolymer solution by heating a mixture of six moles of 37% aqueous formaldehyde and four moles of urea adjusted to pH 8.0 for one hour at 70° C.;
mixing water-insoluble dye precursor solution into said prepolymer solution and rapidly mixing until the desired capsular size is reached;
heating the mixture to 70° C. and maintaining the pH at 8.0 for a period of one hour while maintaining the mixing;
changing the pH of the mixture to 3.8 with 10% of citric acid solution;
continuing the reaction for a period of one-half hour at 70° C. while maintaining the mixing; and
adding water to dilute the thickening mixture and changing the reaction temperature to 55° C. while mixing for an additional 60 minutes.

21. The method as recited as claim 18 further comprises the steps of:
applying said tamper evident paint to a surface; and
examining stained skin of tamperor with an ultraviolet light source, said tamperor having aggressively handled said surface having tamper evident paint.

22. A method of manufacturing an odor generating tamper evident paint comprising the steps of:
providing a scented oil precursor; mixing said scented oil with a mineral oil to make a 40% by weight scented solution;
microencapsulating said scented solution to form a powder having approximately 100 micron diameter microcapsules in said powder;
adding approximately 10 mg of water to each gram of a latex base tint to form a diluted latex base tint; and
mixing approximately 300 mg of said microcapsule powder per gram of diluted latex base tint to form said odor generating tamper evident paint.

23. The method as recited in claim 22 wherein said step of providing a scented oil comprises the step of providing a scented flower oil.

24. The method as recited in claim 22 wherein said step of microencapsulating said dye dispersion comprises the steps of:
providing a prepolymer solution;
forming a non-formaldehyde polymer shell; and
encapsulating said scented oil within said shell.

25. The method as recited in claim 22 further comprises the steps of:
applying said temper evident paint to a surface; and
sensing an odor after a tamperor aggressively handles said surface having tamper evident paint.
